(19) United States
(12) Patent Application Publication
(10) Pub. No.: US 2007/0052995 A1
(43) Pub. Date: Mar. 8, 2007

(54) Portable device capable of printing documents and method of printing documents from portable device

(76) Inventors: Narendranath Kudlu, Bangalore (IN); Bino Sebastian, Bangalore (IN); Sanandan Sharma, Bangalore (IN)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/212,060

(22) Filed: Aug. 24, 2005

(51) Int. Cl. G06F 3/12

(52) U.S. Cl. 358/1.15; 358/1.13

(57) ABSTRACT

A mobile device adapted to print a file and a method of printing a file from a mobile device are disclosed.

### BACKGROUND AND SUMMARY

Mobile telephones and mobile data processing devices, such as personal digital assistants (PDAs), text messaging devices, etc., continue to gain in popularity and usage. Indeed, as the number of applications for these devices continues to increase, the lines between mobile telephone and PDA blur and indeed several combination, or hybrid, mobile devices exist. Mobile devices, including mobile telephones, are now capable of taking and storing photographs, browsing the Internet, playing music, downloading files, receiving and displaying e-mail messages including file attachments, etc.

With these increasing applications, there is an increasing need to be able to easily print a variety of different file types by connecting a mobile device (e.g., a mobile telephone) to a printer. Exemplary file types include text files, word processing files such as MICROSOFT® WORD® documents, ADOBE® PDF® files, Web pages in hypertext markup language (HTML) format, spreadsheet files such as MICROSOFT® EXCEL® files, database files, etc.

Currently, it is not possible to print most of the popular file formats from a mobile device such as a mobile telephone. Most printers today require the installation of a proprietary printer on the device sending the file to the printer to be printed. Accordingly, printers typically are shipped with a disk having a copy of the one or more printer driver(s) loaded thereon, for example, to be connected to a computer running a version of the MICROSOFT® WINDOWS® operating system. When the printer is connected to a computer, the appropriate printer driver has to be pre-installed on the computer for the printer to work properly.

However, this need for each printer to have its own printer driver is a significant problem when trying to print from a mobile device such as a mobile telephone. Unlike personal computers, which have a very few de-facto standard operating systems (principally, MICROSOFT® WINDOWS®), mobile telephones all use a variety of processors and customized software to execute their functions. It is difficult for printer manufacturers to produce the numerous drivers that would be required for the wide variety of different mobile telephones in use. Furthermore, even if such printer drivers were available, since there are so many different printers which all require different drivers, a mobile telephone would need to store hundreds of printer drivers, or have a convenient means for loading new printer drivers, to provide a good likelihood of operating with any particular printer.

There is a need for a method of printing files that overcomes at least the shortcomings described above.

In accordance with an example embodiment, a method of printing a non-image file having a first file format from a mobile telephone, comprises: connecting the mobile telephone to a PictBridge-compliant printer; determining at the mobile telephone that the printer is a PictBridge-compliant printer; receiving at the mobile telephone from the PictBridge-compliant printer capabilities of the PictBridge-compliant printer; converting the file from the first file format to a file format supported by the connected PictBridge-compliant printer; and communicating the file having the converted file format to the PictBridge-compliant printer via a PictBridge print application installed on the mobile telephone.

In accordance with another example embodiment, a method of printing a file from a mobile device, comprises: connecting the mobile device to a PictBridge-compliant printer; converting the file from a first file format not supported by the PictBridge-compliant printer to a file format supported by the PictBridge-compliant printer; and communicating the file having the file format supported by the PictBridge-compliant printer from the mobile device to the PictBridge-compliant printer via a PictBridge print application installed on the mobile device.

In another example embodiment, a mobile device, comprises: memory adapted to store a file having a first file format; a printer interface; a PictBridge print application installed on the mobile device adapted to communicate files through the printer interface; and a PictBridge adaptation application installed on the mobile device adapted to convert the file from the first file format to a file format supported by a PictBridge-compliant printer.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a block diagram of a mobile device connected to a PictBridge-compliant printer in accordance with an example embodiment.

FIG. 2 shows a flowchart for explaining a method by which a mobile device prints a non-PictBridge compatible file on a PictBridge-compliant printer in accordance with an example embodiment.

FIG. 3 shows a communication protocol architecture of a PictBridge print application installed on a mobile device and a corresponding PictBridge application installed in a PictBridge-compliant printer in accordance with an example embodiment.

FIG. 4 illustrates operations of printing a PictBridge compatible file from a mobile device to a printer using PictBridge in accordance with an example embodiment.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

The Camera & Imaging Products Association (CIPA) has developed the PictBridge standard to provide a direct connect solution for image input devices and output devices by standardizing the application services for these devices. In particular, PictBridge provides a direct print service between a digital still camera (hereafter “DSC”) and a printer for printing image files stored on the DSC. PictBridge is described in the CIPA standard “CIPA DC-001.”

As a result of the PictBridge standard, a wide variety of PictBridge-compliant printers are becoming available. A printer is said to be “PictBridge-compliant” if any PictBridge-compliant DSC can print image files on the printer via a PictBridge print application (software) installed on the PictBridge-compliant DSC.

However, PictBridge is designed for printing image files and only requires that a PictBridge-compliant printer must support printing files having an EXIF/JPEG image file format. Although some PictBridge-compliant printers may support printing other types of files through PictBridge, in practice most PictBridge-compliant printers only support image file formats, such as bitmap (bmp), graphical interchange format (gif), tagged image file format (tiff), digital print order format (DPOF), etc. In practice, many PictBridge-compliant printers may only support the EXIF/JPEG image file format.

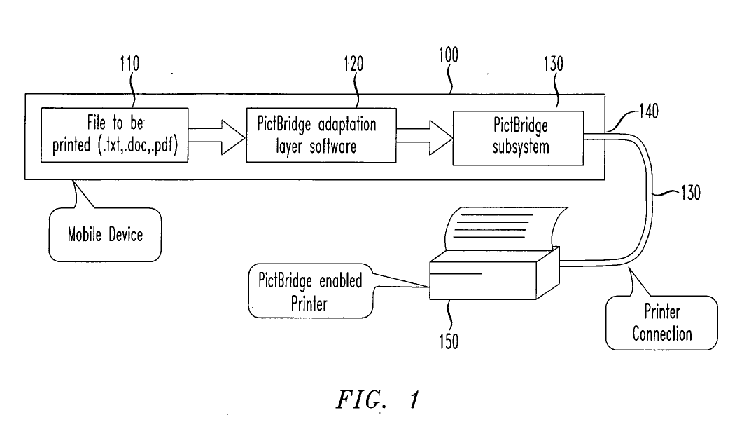

FIG. 1 is a block diagram explaining operation of a mobile device 100 capable of printing a wide variety of documents, including non-image documents, to a variety of printers. In particular, the mobile device 100 of FIG. 1 is a PictBridge-compliant mobile device having a PictBridge print application 130 stored thereon. Mobile device 100 includes memory 110 storing one or more files to be printed, a PictBridge adaptation application 120, a PictBridge print application 130, and a printer interface 140. The mobile device 100 is connected via a printer connection 160 to a PictBridge-compliant printer 150.

Mobile device 100 may include a mobile telephone, a personal digital assistant (PDA) or other mobile data processing device, a text messaging device, a digital camera, a portable music player, or some combination or hybrid device including one or more of the devices described above, such as a device including mobile communications and mobile data processing functionality.

Memory 110 may store a variety of different files having a variety of different file formats. In particular, memory 110 may store a text file, a word processing file, a database file, a spreadsheet file, a presentation file, an ADOBES PDF® file, a hypertext markup language (HTML) file, a binary file, etc. One or more of the files may have a file format that is not supported by the PictBridge-compliant printer 150 to which the mobile device is connected, such as a text file format, a word processor file format (e.g., a MICROSOFT® WORD® file format), a spreadsheet file format (e.g., a MICROSOFT® EXCEL® file format), a presentation file format (e.g., a MICROSOFT® POWERPOINT® file format), an e-mail file format, an HTML or XML file format, an ADOBE® PDF® file format, or a database file format. Beneficially, the file has a filename including a filename extension which identifies the file. In that case, the filename extension may be jpeg, jpg, txt, doc, pdf, wpd, htm, dbf, dot, xml, rtf, ppt, xls, gif, tiff, tif, bmp, etc.

The PictBridge print application 130 is any PictBridge-compliant application installed on the mobile device which allows PictBridge-compatible files to be printed from the mobile device via a PictBridge-compliant printer 150. Beneficially, the PictBridge print application 130 may comprise a software application stored in nonvolatile memory in mobile device 100 and executed by a microprocessor of mobile device 100.

The PictBridge adaptation application 120 is an algorithm that converts a file having a first file format to a PictBridge-compatible file format which can be printed by PictBridge print application 130 on PictBridge-compliant printer 150. Beneficially, PictBridge adaptation application 120 is adapted to convert text files, word processing files, database files, spreadsheet files, presentation files, e-mail files, ADOBE® PDF® files, HTML files, binary files, etc. to the PictBridge mandated EXIF/JPEG file format, or to any other PictBridge-compatible file format that is supported by the particular connected PictBridge-compliant printer 150. Such files may have a text file format, a word processor file format (e.g., a MICROSOFT® WORD® file format), a spreadsheet file format (e.g., a MICROSOFT® EXCEL® file format), a presentation file format (e.g., a MICROSOFT® POWERPOINT® file format), an e-mail file format, an HTML or XML file format, an ADOBE® PDF® file format, a database file format, etc. Beneficially, PictBridge adaptation application 120 may comprise a software application stored in nonvolatile memory in mobile device 100 and executed by a microprocessor of mobile device 100.

Printer interface 140 can be any convenient interface allowing a connection between mobile device 100 and PictBridge-compliant printer 150. Beneficially, printer interface 140 may be a universal serial bus (USB) port, a wireless infrared communication port, such as an Infrared Data Association (IrDA) standard communication port, a BLUETOOTH® wireless port, etc. Other direct wired and wireless printer interfaces may be employed. Alternatively, in some embodiments mobile device 100 may establish a communications link with PictBridge-compliant printer 150 via a wired or wireless network, such a wireless local area network (WLAN), on which PictBridge-compliant printer 150 is installed.

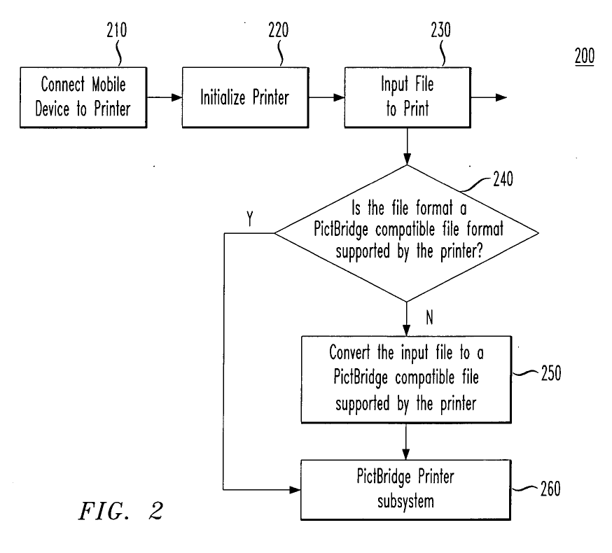

FIG. 2 shows a flowchart for explaining a method 200 by which a mobile device having a PictBridge print application installed thereon prints a file via a connected PictBridge-compliant printer.

In a step 210, a connection is established between a mobile device and a PictBridge-compliant printer. The connection may be established via a USB cable, a wireless infrared connection, a wired or wireless network connection, or another convenient means.

In a step 220, the connection between the mobile device and the PictBridge-compliant printer is initialized. Beneficially, this includes: a first substep of determining at the mobile device that a printer to which the mobile device has been connected is a PictBridge-compliant printer; a second substep of configuring the mobile device and PictBridge-compliant printer to communicate with each other; a third substep of the mobile device inquiring about the capabilities of the PictBridge-compliant printer; and a fourth substep of the PictBridge-compliant printer returning a message to the mobile device indicating its capabilities.

In some cases, step 220 may not be necessary. Also, beneficially, step 220 may be performed immediately after step 210, or at some later time, such as after steps 230 or step 240, below.

In a step 230, a user selects one or more files stored on the mobile device and enters an instruction to print the file. A user may select a file and enter an instruction by pressing an appropriate key or button (or sequence of keys and buttons) on the mobile device, through a point-and-click input device, via a graphical user interface of the mobile device, or any other appropriate input means available. The file may be an EXIF/JPEG image file that the PictBridge standard requires any the PictBridge-compliant printer to support, or it may be another file such as a text file, a database file, a spreadsheet file, a presentation file, an ADOBE® PDF® file, an e-mail file, an HTML file, a binary file, etc. The file may have a text file format, a word processor file format, a spreadsheet file format, a presentation file format, an e-mail file format, an hypertext markup language file format, an ADOBE® PDF® file format, a database file format, etc.

In a step 240, the mobile device determines whether or not the selected file has a PictBridge-compatible file format that is supported by the connected PictBridge-compliant printer, and therefore can be printed by the PictBridge print application on the connected PictBridge-compliant printer. If the file has an EXIF/JPEG file format, then the file can be directly provided to the PictBridge printer application and then sent to the connected PictBridge-compliant printer, as any PictBridge-compliant printer must support this file format. Any other file format will have to be checked to determine whether or not the file has a PictBridge-compatible file format that is supported by the connected PictBridge-compliant printer. If the file has a PictBridge-compatible file format that is supported by the connected PictBridge-compliant printer, then the file can be directly provided to the PictBridge printer application and then sent to the connected PictBridge-compliant printer.

If the file format is not supported by the connected PictBridge-compliant printer and therefore cannot be printed by the PictBridge print application on the connected PictBridge-compliant printer, then the file is provided to the PictBridge adaptation layer software to convert the file into one of the file formats supported by the connected PictBridge-compliant printer. Typically, the connected PictBridge-compliant printer will not support a non image file format such as HTML, text, ADOBE® PDF® file, MICROSOFT® WORD® file etc., as the PictBridge standard has been designed for image printing. Beneficially, the mobile device examines a filename of the selected file, and determines whether or not the selected file is supported by the connected PictBridge-compliant printer in response to a filename extension of the filename indicating a file type not supported by the connected PictBridge-compliant printer. For example, the mobile device may have determined in an earlier step (e.g., step 220) that the connected PictBridge-compliant printer only supports EXIF/JPEG image files. In that case, the mobile device may conclude that a file's file format is not supported by the PictBridge-compliant printer when the filename extension is something other than jpeg or jpg, such as txt, doc, pdf, wpd, htm, dbf, dot, xml, rtf, or xls, gif, tiff, tif, bmp, etc. In another case, the mobile device may determine that the connected PictBridge-compliant printer supports tiff, gif and bmp files, as well as EXIF/JPEG image files. In that case, the mobile device may conclude that a file's file format is not supported by the PictBridge-compliant printer when the filename extension is something other than jpeg, jpg, tiff, bmp, or gif.

In a step 250, when the selected file has a file format that is not supported by the connected PictBridge-compliant printer, and therefore cannot be printed by the PictBridge print application on the connected PictBridge-compliant printer, a PictBridge adaptation application converts the selected file into a format that is supported by the connected PictBridge-compliant printer and can be printed by the PictBridge print application on the connected PictBridge-compliant printer. Beneficially, the PictBridge adaptation application converts text files, word processing files, database files, spreadsheet files, presentation files, e-mail files, ADOBE® PDF® files, binary files, etc. to a file format which is supported by the connected PictBridge-compliant printer. Typically, a PictBridge-compliant printer will not support non-image file formats such as a text file format, a word processor file format, a spreadsheet file format, a presentation file format, an e-mail file format, an ADOBE® PDF® file format, a database file format, etc., and therefore will have to be converted by the PictBridge adaptation application. So, optionally, one embodiment of a PictBridge adaptation application may automatically convert all unsupported files to a EXIF/JPEG file format which is supported by all PictBridge-compliant printers. In another embodiment, the PictBridge adaptation application converts an unsupported file to a file format other than EXIF/JPEG for which the printer may have support, but which may require fewer processing resources (memory, processor cycles, etc.) for the conversion process.

In a step 260, a PictBridge print application installed on the mobile device communicates the file having the PictBridge compatible file format, through the printer interface of the mobile device, to the PictBridge-compliant printer. The PictBridge print application and the PictBridge-compliant printer treat a converted file as they would any PictBridge-compatible file having a file format supported by the connected PictBridge compatible printer.

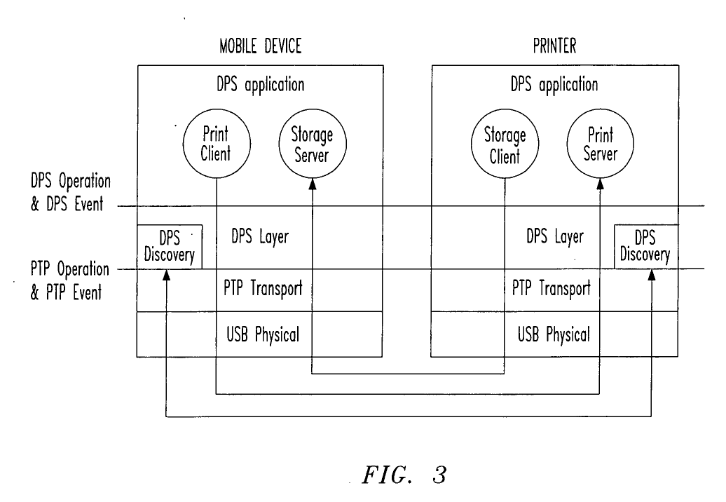

FIG. 3 illustrates a communications protocol architecture of a PictBridge print application installed on a mobile device, and a corresponding PictBridge application in a PictBridge-compliant printer. As shown in FIG. 3, PictBridge defines several software components, which include a print Server/Client and a storage Server/Client at the mobile device print application layer, and DPS discovery at the DPS layer. In PictBridge, the storage client is indirectly initiated by user operations and therefore is not visible to the user. The storage client requests image data to the storage server when the printer executes a print job upon the request of the mobile device. The operations and events of the DPS applications are executed based on a Server/Client model. A print operation consists of a request from a client to a server and followed by a response from the server to the client. A print event consists of a request from a server to the client followed by a response from the client to the server.

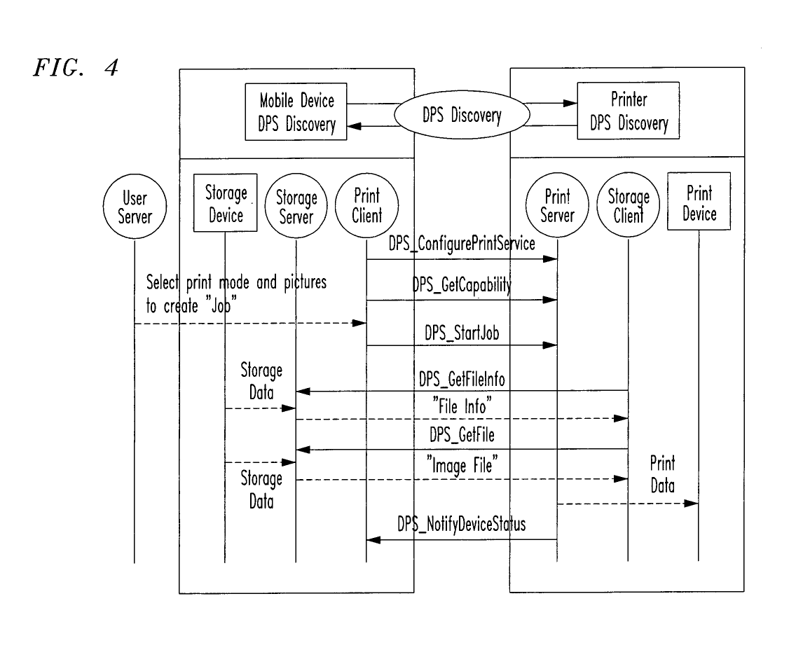

FIG. 4 illustrates operations of printing a PictBridge-compatible file from a mobile device to a printer using PictBridge. FIG. 4 shows a sequential diagram for a single page print job between PictBridge-compliant devices.

Initially, a discovery function confirms if each device supports PictBridge. If PictBridge is available in each device then control is transferred to the mobile print application. Beneficially, after the printer connection is established, discovery is initiated.

Next, a DPS_ConfigurePrintService operation is issued. The DPS_ConfigurePrintService operation communicates which services each device provides. The mobile device notifies the printer that it has the storage server function and the print client function. The printer notifies the mobile device that it has the print server function and the storage client function. Using this negotiation, connection is established between the server and the client for print and storage respectively. All printing operations and events are executed between these client and server combinations.

PictBridge defines a scenario where the user creates the intended print job on the mobile device and then sends a print job to the print server, which then pulls the image files from the storage server on the mobile device.

The mobile device inquires about the capability of the PictBridge-compliant printer by issuing a DPS_GetCapability operation. The capability returned from the printer will direct the UI features displayed on the mobile device. The user can then select the options they want from the features presented and initiate their print job.

When the user initiates a print, the mobile device issues a DPS_StartJob operation. This sends the PictBridge-compliant printer the information it needs to print what the user requested.

When the PictBridge-compliant printer begins to process a job it first issues a DPS_GetFileInfo operation. This operation retrieves details of the file to be printed. This information is used to get the actual file data by a DPS_GetFile operation. The file data is transferred and printed.

After printing is finished the printer notifies the mobile device of the result of the print job by issuing a DPS_NotifyDeviceStatus event.

Accordingly, as described above, any file having a file format not supported by the PictBridge-compliant printer can be printed on a PictBridge-compliant printer by using PictBridge and a PictBridge adaptation application that converts the file to a PictBridge-compatible-file format supported by the connected PictBridge-compliant printer.

In accordance with illustrative embodiments described, a methods of printing files from mobile devices is disclosed. One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

We claim:

1. A method of printing a non-image file having a first file format from a mobile telephone, comprising:
connecting the mobile telephone to a PictBridge-compliant printer;
determining at the mobile telephone that the printer is a PictBridge-compliant printer;
receiving at the mobile telephone from the PictBridge-compliant printer capabilities of the PictBridge-compliant printer;
converting the file from the first file format to a file format supported by the connected PictBridge-compliant printer; and
communicating the file having the converted file format to the PictBridge-compliant printer via a PictBridge print application installed on the mobile telephone.

2. The method of claim 1, wherein the file is one of a text file, a database file, a spreadsheet file, a hypertext markup language file, and a binary file.

3. The method of claim 1, wherein the first file format is one of a text file format, a word processor file format, a spreadsheet file format, an e-mail file format, an hypertext markup language file format, an ADOBE® PDF® file format, and a database file format.

4. The method of claim 1, wherein communicating the file format to the PictBridge-compliant printer via a PictBridge print application installed on the mobile telephone includes communicating the file across a universal serial bus (USB) interface.

5. The method of claim 1, wherein communicating the file having the converted file format to the PictBridge-compliant printer via a PictBridge print application installed on the mobile telephone includes communicating the file across a wireless infrared or radio communication link.

6. The method of claim 1, further comprising:
receiving at the mobile telephone a user instruction to print the file; and
determining that the first file format is not a file format supported by the connected PictBridge-compliant printer.

7. The method of claim 6, wherein determining that the first file format is not a file format supported by the connected PictBridge-compliant printer comprises:
examining a filename of the file; and
determining that the file is not a file format supported by the connected PictBridge-compliant printer in response to a filename extension of the file indicating a non supported file type.

8. The method of claim 7, wherein determining that the first file format is a not a file format supported by the connected PictBridge-compliant printer in response to a filename extension of the file indicating a non-image file type includes determining that the file is not a file format supported by the connected PictBridge-compliant printer in response to the filename extension being one of txt, doc, pdf, wpd, htm, dbf, dot, xml, rtf, and xls.

9. A method of printing a file from a mobile device, comprising:
connecting the mobile device to a PictBridge-compliant printer;
converting the file from a first file format not supported by the PictBridge-compliant printer to a file format supported by the PictBridge-compliant printer; and
communicating the file having the file format supported by the PictBridge-compliant printer from the mobile device to the PictBridge-compliant printer via a PictBridge print application installed on the mobile device.

10. The method of claim 9, wherein connecting the mobile device to a PictBridge-compliant printer includes connecting a universal serial bus (USB) cable between a USB port on the mobile device and the PictBridge-compliant printer.

11. The method of claim 9, wherein connecting the mobile device to a PictBridge-compliant printer includes establishing a wireless infrared or wireless radio including Bluetooth communication link between the mobile device and the PictBridge-compliant printer.

12. The method of claim 9, wherein the file is one of a text file, a database file, a spreadsheet file, an ADOBE® PDF® file, a hypertext markup language file, and a binary file.

13. The method of claim 9, wherein the first file format is one of a text file format, a word processor file format, a spreadsheet file format, an e-mail file format, an hypertext markup language file format, an ADOBE® PDF® file format, and a database file format.

14. The method of claim 9, further comprising:
receiving at the mobile telephone a user instruction to print the file; and
determining that the first file format is a not a file format supported by the PictBridge-compliant printer.

15. A mobile device, comprising:
memory adapted to store a file having a first file format;
a printer interface;
a PictBridge print application installed on the mobile device adapted to communicate files through the printer interface; and
a PictBridge adaptation application installed on the mobile device adapted to convert the file from the first file format to a file format supported by a PictBridge-compliant printer.

16. The mobile device of claim 15, further comprising a mobile telephone.

17. The mobile device of claim 15, further comprising at least one of a digital camera, a personal digital assistant, and a portable music player.

18. The mobile device of claim 15, wherein the printer interface is one of a universal serial bus (USB) port, a wireless infrared, a BLUETOOTH® communication port, a wireless radio communication port, and a network connection port adapted to be connected to a network having a PictBridge-compliant printer installed thereon.

19. The mobile device of claim 15, wherein the file is one of a text file, a database file, and a spreadsheet file, an ADOBE® PDF® file, a hypertext markup language file, and a binary file.

20. The method of claim 15, wherein the first file format is one of a text file format, a word processor file format, a spreadsheet file format, an e-mail file format, an hypertext markup language file format, an ADOBE® PDF® file format, and a database file format.
